(19) United States
(12) Patent Application Publication
(10) Pub. No.: US 2004/0153419 A1
(43) Pub. Date: Aug. 5, 2004

(54) Method and device for the certification of a transaction

(76) Inventors: Jean-Philippe Wary, Bourg La Reine (FR); Daniel Arnassand, Cachan (FR)

Correspondence Address: David D Stein, Boyle Fredrickson Newholm Steinz & Gratz, 250 Plaza Suite 1030, 250 East Wisconsin Avenue, Milwaukee, WI, 53202, US

(21) Appl. No.: 10/479,434

(22) PCT Filed: May 28, 2002
(86) PCT No.: PCT/FR02/01799

(30) Foreign Application Priority Data
Jun. 1, 2001 (FR) 01/07286

(51) Int. Cl. H04K 1/00; H04L 9/00; G06F 17/60

(52) U.S. Cl. 705/71

(57) ABSTRACT

Method and device for the certification of a transaction A problem of the real-time revocation or neutralization of an X509 type certificate available belatedly in a public database (BD) is resolved by the direct neutralization, in a mobile telephone (1), of a sub-program (26) for the signing and/or transmission of certificates pertaining to transactions to be validated. It is shown that this action leads to neutralization within ten minutes following the signalization, or the neutralization request, whereas 24 to 48 hours are needed with normal administrative channels (AE, PB).

An object of the present invention is a method as well as a device for the certification of a transaction. It is chiefly designed for use in all types of mobile telephony (GSM, GPRS, UMTS etc.) and to govern a transaction between a user of a mobile telephone and a partner to the transaction.

The transactions most widely known in the field of transactions are those corresponding to purchases and sales. However, it is also possible to consider a transaction to be the transmission of information to a partner and the entrusting of this partner with the task of ascertaining that the information transmitted to him is not fraudulent but authentic. It is also possible to envisage the use of the invention in the framework of access control: in this case, the transaction results from an access authorization request. For the sake of simplicity, the invention shall be described in the context of a sales operation because such an operation truly represents all the problems that may arise during such a transaction. However, all transactions are concerned by the invention.

In the field of purchases, especially Internet purchases, a purchaser such as a mobile telephone user links up to an Internet site, especially in a WAP (Wireless Application Protocol) session. During this session, he plans a transaction with a partner, namely a supplier of goods or services, who makes his goods or services available on this Internet site. A transaction essentially comprises the preparing of a transaction message. This message can be prepared and issued by any of the actors in the transaction, the user of the mobile telephone or the partner he is addressing. In any case, this partner is, of course, synonymous not only with natural persons or legal entities but also with computer type means in order to link up with the user's mobile telephone and reach common agreement on the nature of the transaction message. In the case of a sale, a transaction message must comprise certain indispensable items of information. These are generally the date, the price of the transaction, the currency, the designation of the object, the serial number of the transaction and the name of the acquiring party. The transaction finally comprises the making available of the good or services purchased and, in return, payment for this transfer.

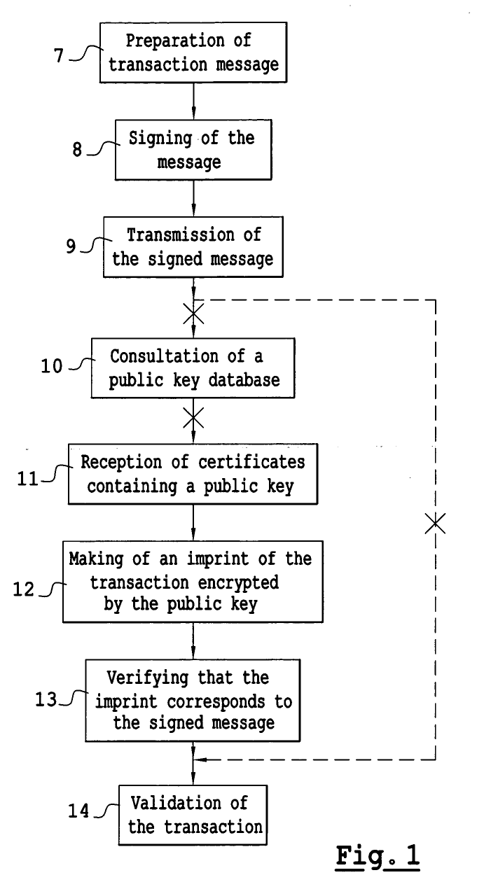

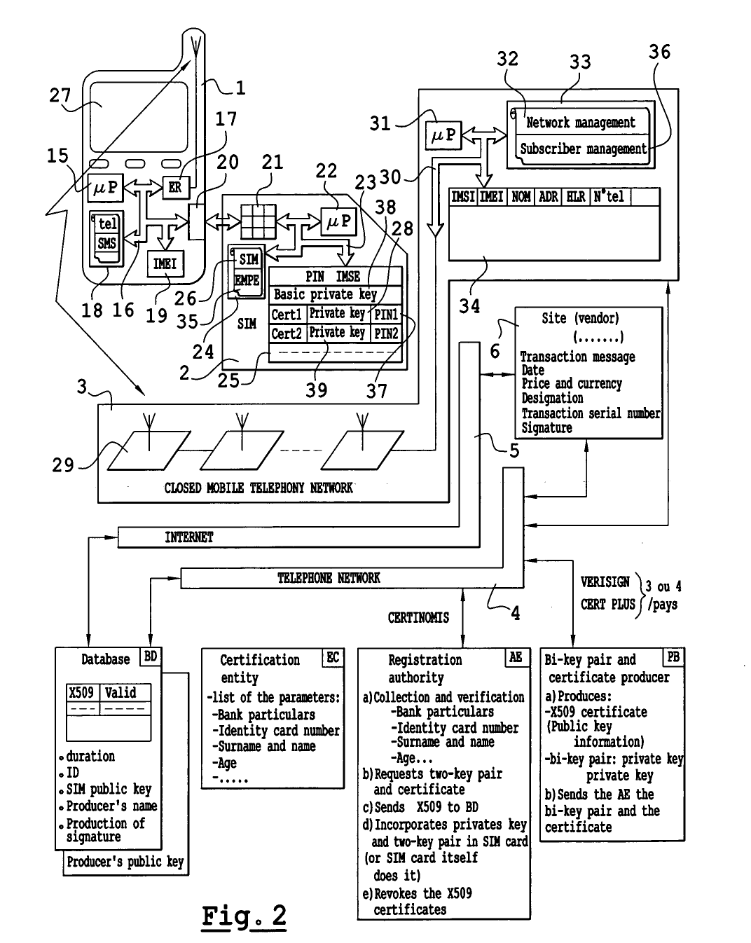

Given its sensitive nature, a transaction message must be secured. A possible securing of the transactions results from the use of symmetrical encryption algorithms. Another possible securing of the transactions results from the use of asymmetrical key encryption algorithms or two-key encryption algorithms, namely algorithms with one private key to sign the message and one public key to verify the authenticity of the signed transaction message. Two essential parameters representing efficient securing of a transaction relate firstly to the property of non-repudiation, owing to the use of a digital signature mechanism which signs the transaction message and, secondly, the confidentiality permitted by the encryption of the contents of the message. The steps of a method corresponding to a signing of such a transaction are shown in FIG. 1 while the means needed to implement it are shown in FIG. 2.

The means used to prepare and put out a transaction message comprise (FIG. 2) a mobile telephone 1 preferably provided with a smart card 2 (preferably a SIM or USIM card used within a third-generation mobile network) and capable of linking up with a mobile telephony network 3. A SIM (Subscriber Identification Module) is a smart card whose chip comprises information on the subscription and authentication of the mobile telephone user. The mobile telephony network 3 may be connected, especially by means of a classic switched telephony network 4, or by means of the Internet 5 with a vendor's site 6, plus generally the site of a partner being addressed by the user of the mobile telephone 1. The site 6 is preferably an Internet site, but this is not an obligation. A Minitel type site can also be envisaged. The mobile telephone 1 and/or the site 6 comprise means which, in a first step 7 (FIG. 1), prepare and put out the message of the transaction. Then the mobile telephone 1, in a step 8, secures the message of the transaction. The message is signed by the issuing party, especially by means of a private key contained in a secret memory of the mobile telephone 1, especially a secret memory contained in the SIM card 2.

The signed message is then transmitted by the mobile telephone 1 to the site 6 in a step 9. This site then implements a method to verify the consistency and the authenticity of the transaction message received. The verification necessitates the use of the public key of the issuing party. This key is generally available in the form of a digital certificate (of the X509 type for example). The supply or recovery of this certificate is done in a step 10 for the consultation of a database of public keys.

In practice, setting up an asymmetrical type of certification system requires action by several entities or authorities leading to the consistency of the management of the public and private keys.

First of all, a certification entity EC, of the standard-setting or normative organization type, defines the conditions of the certification. In particular, for payment messages, the entity EC defines the list of parameters that must be contained by the transaction messages, for example, bank account particulars, identity card numbers, surnames and names of the different users, their age and other particulars. This standard-setting certification entity EC lays down the conditions for the working of recording authorities, AE. These recording authorities AE are entrusted with responsibility for various operations.

First of all, a), they are responsible for the collection and verification of information that must be shown in certificates in accordance with the list of parameters produced by the certification entity.

Secondly, b) these recording authorities AE are responsible for the request to produce an electronic certificate (preferably a X509, V3 or V4 type certificate). Two cases are then possible:

Either there is a two-key pair already existing within the SIM card, and in this case the public key can be extracted by a reading of the card,

Or else the two-key pair has to be produced, and in this case it can be produced by the SIM card itself (it is preferred to use this method which enables the user's private key to be kept confined), and this private key then makes the generated public key available (for reading at its external bus). A second possibility here is that the authority AE generates a two-key algorithm and installs it in the SIM card. However, this type of scenario is weaker in terms of security.

Thirdly, c), the recording authority AE is responsible for sending the certificates that it has requested and obtained to an organization managing a database BD. The authority AE can then link the identifying data already collected with the public key of the subscriber within a certificate.

Fourthly d), the recording authority AE incorporates each private key of a two-key system, in a SIM card at a place in which this private key cannot be read and displayed on an external bus of the mobile telephone 1. As a variant, the operation for the creation of the two-key system and the recording of the private key in the SIM card is carried out by the SIM card itself, if it contains a program to this effect in the program memory. The user's own certificate can be made available to him directly by the loading of this certificate in a secure zone of the SIM card or of the mobile telephone, or indirectly by the use of a logic method achieved by the positioning of a URL (namely the address of an Internet site) in the SIM card instead of the value of the certificate. This URL directly points to a field of the database BD. There is a preference for this approach which offers greater flexibility of management of the certificates.

Finally fifthly, e), the registering authority AE is responsible for revoking X509 certificates for which the users have requested that they should be incapable of being used. A revocation of this kind may be requested for business reasons, or quite simply because the SIM card and/or the mobile telephone 1 had been stolen.

The database BD is normally read-accessible to all through the Internet, and it is read/write accessible, by the recording authority AE only, through a private type link using the telephone network 4. Certificates are recorded in the database BD. Each certificate recording comprises a certificate, for example an X509 type certificate, matched with a validity index. This certificate is valid so long as it has not been revoked by the recording authority AE. To produce the certificates, the recording authority AE addresses a producer CE/PB of certificates and/or of two-key pairs. A certificate producer PB of this kind produces, a) X509 certificates and, possibly, two-key pairs comprising a private key and a public key. A producer PB of this kind is furthermore b) responsible for transmitting this certificate and/or the two-key pair to the recording authority AE. All these productions and transmissions are highly secure.

At the practical level, a certificate that is totally unencrypted comprises an indication of validity in the form of a duration and a piece of information for identifying the user, typically his name, and possibly his address. The certificate also comprises the public key of the SIM card (while the private key of the two-key pair, for its part, has been loaded into a secret region of the SIM card 2). The X509 certificate furthermore comprises the name of the producer PB of the certificates as well as a signature of the certificate by this producer. This signature is a digital sequence, in practice a sequence of bits, encrypted with a private key of the certifier. To verify the consistency of the certificate, the database BD or another database places a public key at the disposal of the certifiers, enabling this verification.

Consequently, the step 10 for verifying the signed transaction messages may be completed without excessive difficulty. To this end, the signed transaction message comprises the references PB of the producer of the certificates and the identity of the mobile telephone 1 user. Thus, the site 6 may access the database BD, or at least the sub-section of the database that concerns the two-key producer PB. In doing so, the site 6 can search in this base for the X509 certificate corresponding to the user whose name it knows. On receiving this request, the database BD, in a step 11, sends the requested certificate to the site 6. The site 6 may furthermore verify the consistency of the certificate.

Furthermore, the site 6 knows firstly the transaction, especially because it has participated in the preparation of the transaction message 7. Secondly, the site 6 knows the signed message of the transaction since the mobile telephone 1 has transmitted this message to it. Thus, the site 6, in a step 12, makes a digital imprint of the transaction. This imprint can be obtained by using a one-way hashing function, of the MD5 or SHA.1 type for example. During a step 13, the site 6 verifies that the signature thus computed corresponds to the signed transaction message received. This verification is obtained by a decrypting of the signature with the user's public key. If the result of this decrypting corresponds to the digital imprint computed during the step 12, the site 6 will have then verified that the signature truly relates to the transaction message and that the user is truly its source. If this verification is conclusive, the site 6 prompts a validation 14 of the transaction. This validation of the transaction, in the case of access control, may enable the mobile telephone user to access a protected place. This validation may also enable the undisturbed use of information transmitted when it is a transmission of information. In the case of a sale, this validation gives rise to the physical opening (at an agreed place) of a counter for making the goods or services that the mobile telephone 1 user has acquired in this transaction available to him, and more generally for actually delivering these goods or services to him.

A secure procedure of this kind is therefore designed to prevent fraud, especially the fraudulent use of stolen mobile telephones. In practice, when the user has his mobile telephone purloined or when he no longer wishes to use a certificate (for example because the recording authority AE is affiliated with a bank with which he has just terminated relations), he asks the recording authority AE to revoke the relevant X509 certificate in the database BD. Consequently, all transactions launched with the private key corresponding to this revoked certificate will result in the failure of the step 13, and ultimately in the blocking of the transaction. A revocation this kind suffers nevertheless from a lack of efficiency in real-time. In practice, the revocation of the certificates requires 24 to 48 hours depending on whether the authorities concerned are located in the same country or in different countries, or even in countries different from that of the manager of the site 6.

Furthermore, other problems arise owing to congestion in the networks 4 and especially 5, and communications difficulties. It can happen, for example, that the database BD cannot be consulted at the step 10 because of temporary congestion on the Internet for example. For the same reasons, it may also happen that it will not be possible to transmit the certificate containing the revoked public key (or even that this certificate will be transmitted with a valid state, although it has been revoked while the database BD has not been updated). It then happens, in this case, that the partner to the transaction is deprived of the security, which is momentarily inaccessible, and accepts the transaction as presented. He then incurs the risks of fraud all by himself. The problem of real-time revocation is thus a serious problem that must be resolved.

In the invention, it is planned to remedy this problem of real-time revocation, which cannot be resolved at present, by preventing the mobile telephone, in real time or almost in real time, from correctly signing or transmitting any signed transaction message. This greatly increases confidence in the certified transaction operation. To this end, a real-time preventive action is obtained by making the services of the mobile telephony operator of the network 3 send a message to the mobile telephone 1, and especially to the SIM card 2. The aim of this message is to deactivate the means for the correct use of the private key confined in the user's SIM card. This message has the effect of making the SIM card 2 lose the means of correctly using its private encryption key. It will be seen that these means of correct use may come into action at different stages, namely the stages of limiting the production of an correct signed message or limiting the transmission of the correct signed message. By acting in this way, in the invention, the process is stopped from the step 8 onwards or from the step 9 onwards. The real-time intervention may be activated either by the user of the telephone 1 who informs the operator of the mobile telephony network 3, or by the database BD which informs this same operator. In both cases, the absence of consultation of the database BD cannot lead to a situation where an undesired transaction is validated and hence lead to cancellation or revocation of this transaction.

Another advantage of the method according to the invention is provided by the fact of total asynchronism between the electronic signatures of transactions and the reference system for the validity of the certificate.

An object of the invention is a method of certification in mobile telephony between a user of a mobile telephone and a partner in which a message of a transaction between the user and the partner is prepared, the message being signed by means of a signature and authentication algorithm, wherein, to authorize a revocation of the real-time transaction, the transaction message is prevented, in the mobile telephone, from being correctly signed and/or correctly transmitted by neutralizing the method of signature and/or of transmission of the transaction certificate to be validated.

Indeed, the method according to the invention is independent of the encryption technology implemented to make the digital signatures and may therefore be applied to secret key technologies (symmetrical encryption algorithms) or two-key (asymmetrical key and asymmetrical encryption algorithm) technologies.

Thus, an object of the invention is a method of certification of transactions in mobile telephony between a user of a mobile telephone and a partner wherein:

a message of a transaction between the user and the partner is prepared,

the message of the transaction is signed with a private key of the user, this private key being contained in the mobile telephone of the user,

the signed transaction message is transmitted to the partner,

the partner must procure the public key corresponding to the user,

the partner must verify the transaction message signed by means of the corresponding public key,

wherein, to authorize a revocation of the transaction in real time,

the transaction message is prevented, in the mobile telephone, from being correctly signed and/or correctly transmitted and, to this end, the use of the private key contained in the mobile telephone is neutralized.

An object of the invention is also a device for the certification of a message of a transaction comprising:

a mobile telephone provided with a secret memory,

a microprocessor, and

a program memory containing an algorithm for the signing of the private key contained in the secret memory and a sub-program for the transmission of the signed message,

wherein the device comprises:

a means to make the signature and/or the transmission incorrect.

The invention will be understood more clearly from the following description and from the accompanying figures. These figures are given purely by way of an indication and in no way restrict the scope of the invention. Of these figures:

FIG. 1, already commented upon, shows the steps of a certification according to the prior art;

FIG. 2 shows the means implemented to achieve the certification according to the prior art and the revocation of the certification according to the invention.

FIG. 2 shows the mobile telephone 1 that can be used to implement the method of the invention. This mobile telephone 1 conventionally comprises a microprocessor 15 linked by means of a data, address and control bus 16 with transmission/reception circuits 17, a program memory 18, and a data memory 19. The bus 16 is also linked with an interface 20 (in practice a connector) used to set up a link with a smart card 2, especially a SIM type card, by means of a connector 21. In the same way, the chip of the card 2 comprises a microprocessor 22 linked by a bus 23 of the same type as the bus 16 with a program memory 24 and a data memory 25. The microprocessor 22 is capable of implementing a sub-program 26, herein called SIM, contained in the program memory 24. The SIM sub-program is a classic type program that can be used, especially during a first connection of the mobile telephone 1 to the mobile telephony network 3, to demand the keying in of a PIN (Personal Identification Number) code for the use of the mobile telephone, and the transmission to the operator's services of an IMSI (International Mobile Subscriber Identification) number. This PIN and IMSI information is contained in secret zones of the memory 25. These secret zones are not accessible to the user, especially in order to make it impossible for him to view this information on a screen 27 of the mobile telephone 1.

In the context of the transaction signatures, the sub-program 26 also comprises an encryption algorithm. This encryption algorithm uses a private key 28 contained in the memory 25 to sign a digital imprint or a transaction message. The transaction message is drawn up in terms which may have been displayed on the screen 27 and which, at least, have been the object of negotiation during an exchange with the site 6, especially by means of the network 3 and the Internet 5. Furthermore, this transaction message may itself be signed by the site 6, by means of the use of the private key of the site as described here above. In practice, the information on the transaction may come from the Internet 5. However, the signed transaction message is preferably conveyed by the network 3 and the network 4 to reach the site 6.

During the first connection of the subscriber, especially when this subscriber reconnects the battery of his mobile telephone 1, the network 3 receives the signaling messages sent by telephone 1 and picked up by one of the base stations 29. After the phase of access control to the mobile network (implementing the methods of authentication of the user proper to the network, with the particular use of one of the pieces of secret data of the SIM card), the user is considered to be localized. From this instant onwards, the user can communicate, by means of his telephone, with the exterior (by means of a telephone call) or with the network itself (for example by means of an SMS stream).

The telephone network is capable of communicating with the mobile and the SIM card and the user, as soon as the user is localized (upon the activation of the mobile or upon an exit from a tunnel, etc.) and it is capable of doing this independently of the user's actions. In particular, the mobile can receive SMS when setting up a voice or “data” (data transmission) call.

In practice, this station 29 transmits these signaling signals by means of a 30 to a processor 31 which implements a telephony network management program 32 contained in a program memory 33. In a data memory 34 of the operator's services, the program 32 creates recordings that set up a correspondence between the IMSI number of the subscriber, and possibly the IMEI number of his mobile telephone, the name (referenced NOM) of this subscriber, his address ADR (in order to send him invoices corresponding to his use of connection time), the location his mobile HLR well as his telephone number. Other information can be brought into correspondence in a recording of the memory 34. The location HLR makes it possible to identify the base station 29 through which the telephone 1 is linked up with the network 3. The telephone number is used to send the mobile telephone 1 calls addressed to it from the exterior, especially through the telephone network 4.

According to the invention, the mobile telephone 1, and more precisely the SIM card 2, possesses means to prevent the transaction messages from being correctly signed and/or correctly transmitted. For example, these preventive means comprise a sub-program 35, EMPE, to prevent signature or correct transmission. The sub-program 35 is preferably contained in the program memory 24. This sub-program 35 is put to use in various ways.

In a preferred way, the sub-program 35 is put into action by an SMS message in GSM type mobile telephony or other types of telephony systems. An SMS (Short Message Service) type of transmission mode is used to constitute three classes of messages: messages executables by the processor 22 of the SIM card 2, messages executables by the processor 15 of the mobile telephone 1, and messages that can be directly stored in the data memory 19, without processing. Preferably the preventive (and hence neutralization) message will be a message of the first type (but the neutralization could of course be launched also by a message of the second type).

The neutralization comprises, for example, either the alteration of the private key 28 or the alteration of the part of the sub-program 26 corresponding to the encryption (inactivation of the signature on this private key specifically), or again the altering of the part of the sub-program 26 corresponding to the transmission of the signed transaction message. For example, it is possible, in the memory 25, to alter the value of the private key 28. In practice, it is enough to change the value of one of the bits so that a signature with a private key of this kind is no longer consistent with the verification of the imprint made with the public key which is supposed to correspond to it, and which the site 6 would have picked up in the database BD (before it is correctly updated).

In another way, in the sub-program 26 it is possible, at the position of the instructions pertaining to the signature algorithm, to change the designation of the address at which the encryption key has to be picked up. In this way, there is no need to touch this key which may then furthermore be protected in a totally inviolable way. Or else it is possible to change one of the arguments of the signature operation, especially a shift operator or an arithmetic operation of this algorithm.

As a variant, the key 28 may be matched with a validity index, which for its part no longer needs to be located in an inviolable zone and which, advantageously, may possess the particular feature wherein it can be only be switched irreversibly from a first valid state to a second invalidation state. Thus, the encryption algorithm of the sub-program 26 comprises a preliminary step for verifying the fact that the private signature key to be used is valid, by consultation of this validity index.

All the modifications made to the key 28 can also be made to the instructions of the algorithm itself. In particular, the part of the sub-program 26 corresponding to this signature may itself be matched with a validation index which would have been invalidated.

The following is the implementation of the method of the invention. The user of the telephone 1 links up with the general services of the operator of the mobile telephony network 3. He can also directly address the certification entity or authority EC which has issued the certificate to him, to obtain the revocation of said certificate. The authority EC then links up with the operator of the mobile network to get this revocation done. This link-up can then be implemented automatically at the network by the authority EC itself, if the operator of the mobile network has previously made the necessary technical means available. It is thus possible, especially by means of an agent of this operator, to implement a subscriber management program 36. According to the invention, this program 36 then comprises a sub-program for sending the neutralization message intended for the mobile telephone 1 and/or for the SIM card 2. The program 36 therefore comprises the localizing, by means of the information HLR, of the base station 29 to which is connected the mobile telephone whose IMSI number corresponds to the name and telephone number of the subscriber who has just called. The sub-program 36 therefore sends the neutralization method, especially on a signaling channel (especially with SMS type messages), to the mobile telephone 1. Since the message is on a signaling channel, the user of the mobile telephone 1 is not particularly warned of it. The messages are sent to the mobile telephone 1, even when it is in standby mode. The neutralization message received by the mobile telephone 1 is then sent to the SIM card 2 which implements the sub-program 35 giving rise to the desired neutralization.

If the mobile telephone 1 is disconnected, in particular if it is electrically stopped, when the signaling message is prepared and issued by the program 36, the information HLR marks a connection fault of the mobile telephone 1. This mobile telephone 1 therefore cannot be called up by the network 3. This disconnection may furthermore result from a momentary disconnection, owing to poor conditions of reception (in a passage under a tunnel for example). During the reconnection, the relocalization of the mobile telephone 1 prompts the updating of the HLR information in the memory 34. This updating of the HLR information is then exploited, according to a modification proper to the invention of the sub-program 36, in order to transmit an already prepared neutralization message. In other words, the neutralization message is sent if the HLR information is valid, or else this neutralization message is put on hold and sent out as soon as the HLR type information becomes valid during a reconnection or a relocalization.

In order to ensure that the neutralization message is correctly received in the mobile telephone 1 and/or in the SIM card 2, this neutralization message will comprise an acknowledgment of receipt message. The memory 34 must preferably be informed of the effective reception and execution of the neutralization message. To this end, the use of the SMS type protocol is preferred because this protocol, in itself, comprises an acknowledgement of receipt message of this kind.

In order to take steps against untimely neutralization, the sub-program 35 will comprise a verification of the identity of the actor sending the neutralization message. Indeed, this actor is not necessarily the operator of the mobile telephony network 3, but may be an actor of another type. For example, it may be a bank addressed by the user. The neutralization message then comprises an identification key which must be recognized by the sub-program 35. Or again, the neutralization message is itself encrypted and/or signed and must be decrypted and/or verified by the program 35. To this end, the recording 28 of the private key is matched with a corresponding recording of an administrative key 37, PIN1 for the private key 28. In this case, the sub-program 35 reads the key 37, and, with this key 37, decrypts or authorizes the execution of the neutralization program, and neutralizes the corresponding key 28. If need be, the key 37 may be stored in the memory 19, the sub-program 35 being implemented by the microprocessor 15 and being contained in the program memory 18. In other words, the preventive algorithm corresponding to the preventive message is executed if rights represented by the key 37 allow it.

As a variant, rather than modifying the mode of signature with the private key 28, the neutralization may have the effect of preventing the transmission, according to the step 9, of the message signed by the mobile telephone 1. In this case, it is the corresponding part in the program TEL of operation of the mobile telephone 1, contained in the memory 18, which is modified (or equally well invalidated). As a variant, rather than preventing the sending of a correct signed transaction message, the invention brings about the sending of a message which is of course incorrect but above all indicates, preferably in unencrypted form, that the signature of the transaction cannot be concluded or that the encryption key has been neutralized. Or else it brings about the sending of any other message capable, in unencrypted or encoded form, of preventing the performance of one of the steps 10 to 13 of an experiment on a correct transaction, and of preventing at least the validation 14 of the transaction should the operations 10 to 13 not be launched.

Just as, for highly sensitive operations (especially purchases) it may be necessary to have a procedure requiring the intervention of a recording authority AE and a producer PB of two-key pairs and certificates, so in certain cases, for transactions whose cost or importance may be lower, such a procedure may appear to be cumbersome. For example it is possible that a private organism, an oil company, may itself wish to manage the instructions and the neutralization of the private keys that it assigns and the certificates that it creates. In this case, in the context of the use of a basic private key 38 stored in the memory 25, this organism may prompt the recording 39 of certificates, complementary private keys and neutralization decryption codes in this memory 25. Typically, the keys 39 may result from program elements called APPLETS programmed in JAVA language, capable of interpretation by a virtual machine stored in the program 26 of the SIM card 2 and making these updates downloadable from the network 3. These program elements may themselves be downloaded in the memory 24.

1- A method of certification in mobile telephony between a user of a mobile telephone and a partner in which a message of a transaction between the user and the partner is prepared, the message being signed by means of a signature and authentication algorithm, wherein, to authorize a revocation of the real-time transaction, the transaction message is prevented, in the mobile telephone, from being correctly signed and/or correctly transmitted by neutralizing the method of signature and/or of transmission of the transaction certificate to be validated.

2- A method for the certification of transactions in mobile telephony between a user of a mobile telephone (1) and a partner (6) in which
a message of a transaction between the user and the partner is prepared (7),
the message of the transaction is signed (8) with a private key (28) of the user, this private key being contained (2) in the mobile telephone of the user,
the signed transaction message is transmitted (9) to the partner,
the partner must procure (10, BD) the public key (X509) corresponding to the user,
the partner must verify (12) the transaction message signed by means of the corresponding public key,
wherein, to authorize a revocation of the transaction in real time,
the transaction message is prevented (35), in the mobile telephone, from being correctly signed and/or correctly transmitted and, to this end, the use of the private key contained in the mobile telephone is neutralized.

3- A method according to claim 2 wherein, in order to neutralize the use,
an address of the private key is modified in a SIM card of the mobile telephone.

4- A method according to one of the claims 2 to 3 wherein, to neutralize the use,
the private key is altered in a SIM card of the mobile telephone.

5- A method according to one of the claims 2 to 4, wherein to neutralize the use,
a signature algorithm is modified in a SIM card of the mobile telephone or in a program memory of the mobile telephone.

6- A method according to one of the claims 2 to 5 wherein, to neutralize the use,
an address of at least one instruction of a signature algorithm is modified in a SIM card of the mobile telephone or in a program memory of the mobile telephone.

7- A method according to one of the claims 2 to 6 wherein, to neutralize the use,
the private key is matched with a validity index, and the value of this index is modified.

8- A method according to one of the claims 1 to 7, wherein
in the mobile telephone, the transaction message is prevented from being correctly signed and/or correctly transmitted as soon as (36) a revocation order is received in a database.

9- A method according to one of the claims 1 to 8, wherein
in the mobile telephone, the transaction message is prevented from being correctly signed and/or correctly transmitted through the prompting therein of a modification of the first connection (HLR) to the network of this mobile telephone, or during a relocalization.

10- A method according to one of the claims 1 to 9, wherein
an actor, especially a mobile telephony operator, sends a preventive message to a mobile telephone,
rights (37) pertaining to the sending a prevention message by this operator are verified in the mobile telephone, and
a prevention algorithm corresponding to the prevention message is executed if the rights allow it.

11- A method according to one of the claims 1 to 10, wherein
the prevention is done in the mobile telephone by the sending of a prevention message transmitted by SMS.

12- A method according to one of the claims 1 to 11, wherein
the mobile telephone is made to transmit a message according to which the transaction is impossible.

13- A method according to one of the claims 1 to 12, wherein
a recording is made in a mobile telephone, through remote transmission by the network, of a certificate, a private key corresponding to this certificate and an administrative authentication key.

14- A device for the certification of a message of a transaction comprising:
a mobile telephone (1) provided with a secret memory (25),
a processing microprocessor (22), and
a program memory (24) containing an algorithm (26) for the signing of the message by a private key (28) contained in the secret memory and a sub-program (26) for the transmission of the signed transaction message,
wherein the device comprises:
a means (35) to make the signature and/or the transmission incorrect.

15- A device according to claim 14, wherein the neutralization means comprises a means for executing a neutralization sub-program.

16- A device according to claim 15, wherein the neutralization sub-program comprises a verification of action conditioned by an administrative key (37) contained in the secret memory.
